(19) United States
(12) Patent Application Publication
(10) Pub. No.: US 2026/0368443 A1
(43) Pub. Date: Nov. 19, 2026

(54) INTEGRATING TIME-SERIES FORECASTING WITH UNSTRUCTURED DOCUMENT MODELING TO GENERATE PREDICTIVE NARRATIVE TEXT

(71) Applicant: Remix Labs LLC, Old Greenwich, CT (US)

(72) Inventors: Thiam Hui Lee, New York, NY (US); Amir Husain, Austin, TX (US)

(73) Assignee: Remix Labs LLC, Old Greenwich, CT (US)

(21) Appl. No.: 19/222,849

(22) Filed: May 29, 2025

Related U.S. Application Data
(63) Continuation-in-part of application No. 19/209,420, filed on May 15, 2025.

(51) Int. Cl. G06F 40/40; G06F 40/279; G06N 3/0442

(52) U.S. Cl. CPC G06F 40/40; G06F 40/279; G06N 3/0442

(57) ABSTRACT

A computer-implemented system and method are provided for generating predictive narrative text by integrating time-series forecasting with unstructured document modeling. The invention receives time-series data from one or more data sources and applies predictive models to forecast future values. In parallel, it extracts key entities and concepts from collections of unstructured documents—such as financial reports, regulatory filings, or healthcare records—using advanced natural language processing algorithms. The system correlates the forecasted time-series values with the extracted entities and concepts, synthesizing this information into a predictive narrative text that plausibly reflects future scenarios grounded in both quantitative forecasts and qualitative context. The architecture supports iterative refinement of the narrative, user-selectable parameters for tailoring forecast horizons and scenario constraints, and flexible sourcing of time-series data either from structured datasets or directly from unstructured documents. By automating the alignment and synthesis of disparate data types, the invention enables scalable, context-aware predictive narrative generation, overcoming technical barriers of prior art and supporting robust, actionable decision-making.

### CROSS-REFERENCE TO RELATED APPLICATION

This application claims priority to and a continuation-in-part of U.S. patent application Ser. No. 19/209,420, entitled “Automated Time Series Synthesis Through Intelligent Model Selection,” filed May 15, 2025, the entirety of which is incorporated herein by reference.

### BACKGROUND OF THE INVENTION

### 1. Field of Invention

The invention pertains to artificial intelligence, specifically for generating synthetic time series data designed to enable downstream narrative generation systems that integrate time series forecasts with unstructured document modeling.

### 2. Description of Related Art

In many data-driven industries, the integration of artificial intelligence (AI) into computer-implemented systems has become essential for extracting actionable insights from large and complex datasets. A particularly acute technical challenge arises when these AI systems attempt to generate predictive narratives by combining quantitative time series data with qualitative information extracted from unstructured documents such as financial reports, regulatory filings, or healthcare records.

Forecasting future values using time-series data is a fundamentally difficult challenge for AI due to a combination of technical, mathematical, and practical factors. First, real-world time-series data often suffers from missing values, inconsistencies, or irregular sampling intervals, all of which can degrade the quality of input data and weaken the reliability of AI forecasts. In many cases, especially with new products or emerging markets, there may be insufficient historical data for AI models to learn meaningful patterns, making it hard to train models that generalize well to unseen scenarios. These deficiencies undermine the ability of computer systems to reliably forecast future values using AI models, as the models require robust, high-quality data to learn temporal patterns and make accurate predictions. At the same time, extracting meaningful entities and concepts from unstructured document such as earnings reports, regulatory filings, or healthcare records requires advanced natural language processing algorithms that operate at significant computational cost and complexity. The difficulty is compounded when these two streams of information must be correlated within a computer system. Aligning quantitative forecasts with qualitative, context-rich data from unstructured sources demands sophisticated data fusion algorithms and iterative computational workflows.

Prior art approaches to integrating time-series forecasting with unstructured document modeling in computer-implemented systems have relied on a range of traditional statistical and machine learning techniques, but these methods consistently fall short in achieving seamless, automated data fusion within a computer environment. Classical time-series forecasting models, such as Autoregressive Integrated Moving Average (ARIMA), exponential smoothing, and early deep learning methods, are designed to process structured, numerical data and lack native mechanisms for incorporating qualitative, context-rich information from unstructured sources like earnings reports or news articles. As a result, these systems typically operate in isolation, with time-series models making predictions based only on historical quantitative data, while natural language processing (NLP) models extract entities and concepts from text without direct alignment to quantitative trends.

Efforts to bridge this gap have included hybrid and multimodal models that attempt to combine numerical and textual data, but these approaches are often limited by the complexity of aligning fundamentally different data types and temporal contexts. For example, some systems use feature-level fusion, where extracted features from text and time series are concatenated or combined before being fed into a predictive model. However, this process usually requires extensive manual feature engineering, careful temporal alignment, and domain-specific customization, making it labor-intensive and prone to errors. Other approaches, such as late fusion or decision-level fusion, combine the outputs of separate models, but this can oversimplify the nuanced relationships between qualitative and quantitative information, resulting in coarser, less reliable outputs.

Recent research has proposed advanced neural architectures, such as multi-step interrelation networks, to jointly learn from both modalities. While these models represent a technical advance, they are typically focused on improving prediction accuracy rather than enabling transparent, automated correlation between time-series forecasts and relevant textual entities. Moreover, they often require large, well-annotated datasets and significant computational resources, which are not always available in practical applications. In practice, many organizations resort to ad hoc solutions, such as manually linking news events to time-series anomalies or using simple keyword matching, which do not scale and are not robust to the diversity and complexity of real-world data.

Consequently, prior art systems either oversimplify the integration—failing to capture the true relationships between structured and unstructured data—or demand extensive manual intervention, undermining the reliability, efficiency, and scalability of the process. These limitations result in outputs that are often unreliable and require significant human oversight, leading to inefficient use of computational resources and hindering the development of fully automated, computer-implemented predictive narrative systems. Accordingly, there is a need for a technical solution that enables seamless, automated integration of time-series forecasting with unstructured document modeling, allowing computer systems to generate predictive narratives that are both statistically grounded and contextually meaningful.

### SUMMARY OF THE INVENTION

The present invention provides a novel computer-implemented system that overcomes longstanding deficiencies in the field by combining predictive modeling with advanced natural language processing to generate predictive narratives that are both statistically robust and contextually meaningful. This system operates iteratively, refining its narrative output by continuously aligning forecasted time-series values with key entities and concepts extracted from unstructured documents, thereby enhancing the plausibility and relevance of the generated narratives. By offering user-selectable parameters and supporting a wide range of data sources and document types, the invention enables scalable and automated narrative generation at a level of sophistication and efficiency not previously attainable. As a result, it significantly enhances the ability of computer systems to process, correlate, and synthesize disparate forms of data, effectively overcoming technical barriers that have limited the reliability and scalability of predictive narrative generation in prior art.

In an embodiment of the invention, a computer-implemented method for generating predictive narratives comprises the steps of: receiving time-series data from one or more data sources; applying one or more predictive models to the time-series data to forecast future values; extracting key entities and concepts from a collection of unstructured documents using a natural language processing model; correlating the forecast future values with the extracted key entities and concepts; and generating a predictive narrative text that reflects a plausible future scenario based on the correlated forecast future values with the extracted key entities and concepts, wherein the predictive narrative text is not randomly generated. The time-series data may comprise financial, user growth, or energy usage data. The unstructured documents may include earnings reports, regulatory filings, or healthcare records. The method may further comprise refining the predictive narrative text over multiple iterations to improve alignment between the forecast future values and plausible future scenario. The method may also further comprise tailoring the predictive narrative text through user-selectable parameter to a desired forecast horizon, key entity, or scenario constraint. The time-series data may be organized according to an ordering variable selected from the group consisting of: spatial coordinates, sequential identifiers, dimensional measurements, energy-related variables, hierarchical structures, process-based progressions, developmental indicators, or environmental conditions. The predictive model may be selected from the group consisting of: a long short-term memory (LSTM) model, a gated recurrent unit (GRU) model, a linear model, or a neural basis expansion analysis time series (N-BEATS) model. The natural language processing model further comprises named entity recognition, topic modeling, or sentiment analysis. The method may also further comprise the step of exporting the predictive narrative text to an external analytics or reporting system. The predictive narrative text may include an explanation of how the forecasted values and extracted entities were correlated.

In another embodiment of the invention, a computer-implemented system for generating predictive narratives, comprises: a data ingestion module configured to receive time-series data from one or more data sources; a document processing module configured to extract key entities and concepts from a collection of unstructured documents using a natural language processing model; a predictive modeling module configured to apply one or more predictive models to the time-series data to forecast future values; a correlation module configured to correlate the forecast future values with the extracted key entities and concepts; and a narrative generation engine configured to generate a predictive narrative text that reflects a plausible future scenario based on the correlated forecast future values and extracted key entities and concepts, wherein the predictive narrative text is not randomly generated. The system may further comprise a user interface configured to receive user-selectable parameters for tailoring the predictive narrative text to a desired forecast horizon, key entity, or scenario constraint. The document processing module may be further configured to extract time-series data directly from the unstructured documents. The correlation module may be further configured to temporally align forecast future values with time-referenced entities or events extracted from the unstructured documents. The system may further comprise a feedback module configured to enable iterative refinement of the predictive narrative text based on user input or system-detected inconsistencies.

In yet another embodiment of the invention, a non-transitory computer-readable storage medium storing instructions that, when executed by a processor, cause the processor to perform operations comprising: receiving time-series data from one or more data sources; extracting key entities and concepts from a collection of unstructured documents using a natural language processing model; forecasting future values using one or more predictive models applied to the time-series data; correlating the forecast future values with the extracted key entities and concepts; and generating a predictive narrative text that reflects a plausible future scenario based on the correlation, wherein the predictive narrative text is not randomly generated. The instructions may further cause the processor to receive user input specifying a forecast horizon, key entity, or scenario constraint, and to tailor the predictive narrative text accordingly. The instructions may further cause the processor to extract time-series data from the unstructured documents. The instructions may also cause the processor to iteratively refine the predictive narrative text based on user feedback or system-detected misalignment between forecasted values and extracted entities.

The present invention provides offers several advantages that address longstanding challenges in the integration of time-series forecasting with unstructured document modeling. By uniting predictive modeling and advanced natural language processing within a single computer-implemented system, the present invention enables the automated generation of predictive narratives that are both statistically robust and contextually meaningful. This approach allows the system to iteratively refine narrative outputs, ensuring that forecasted values from time-series data are plausibly and coherently aligned with relevant entities and concepts extracted from unstructured documents such as financial reports, regulatory filings, or healthcare records. The invention's support for user-selectable parameters and its compatibility with multiple data sources and document types provide a high degree of flexibility and scalability, making it suitable for a wide range of forecasting and scenario analysis applications.

Unlike prior art, which often requires manual feature engineering, extensive customization, or ad hoc data fusion techniques, the present invention delivers a seamless, automated workflow for correlating quantitative forecasts with qualitative insights. This not only enhances the reliability and relevance of generated narratives but also significantly reduces the need for human intervention, improving efficiency and scalability. The system's iterative refinement process helps ensure that the resulting predictive narratives remain both plausible and grounded in real data, overcoming the limitations of traditional models that treat structured and unstructured data streams in isolation. Ultimately, the present invention advances the state of the art by empowering computer systems to synthesize, correlate, and present complex, multi-modal information in a manner that supports more informed, data-driven decision-making.

The preceding paragraphs have been provided as a general introduction and are not intended to limit the scope of the following claims. The described embodiments and further advantages will be best understood by reference to the following detailed description in conjunction with the accompanying drawings.

### BRIEF DESCRIPTION OF THE DRAWING

For a complete understanding of the present invention and its advantages, reference is now made to the ensuing descriptions taken in connection with the accompanying drawings briefly described as follows:

FIG. 1 illustrates a system architecture according to an embodiment of the invention and

FIG. 2 illustrates a method according to an embodiment of the invention.

### DETAILED DESCRIPTION OF PREFERRED EMBODIMENTS

Aspects of the present invention are best understood by reference to the detailed description set forth herein. However, it should be understood that the following description, while indicating preferred embodiments and numerous specific details, is given by illustration only and should not be considered limiting. Changes and modifications may be made without departing from the spirit and scope thereof, and the present invention herein includes all such modifications.

The present invention provides a comprehensive, computer-implemented system and method for generating predictive narrative text by seamlessly integrating time-series forecasting with unstructured document modeling. Designed to overcome the technical limitations of prior art, the invention features a modular architecture that orchestrates the automated ingestion, validation, and processing of both structured quantitative data and unstructured textual sources. The system is highly adaptable, supporting not only time as the primary ordering variable but also alternatives such as spatial coordinates, sequential identifiers, dimensional measurements, energy-related variables, hierarchical structures, process-based progressions, developmental indicators, and environmental conditions. This flexibility enables synthesis and narrative generation across a wide range of application domains.

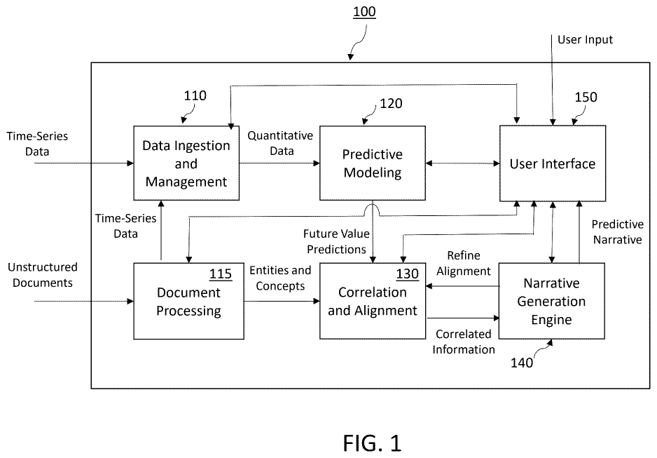

Referring to FIG. 1, a system 100 is composed of several functional modules according to an embodiment of the invention. The data ingestion and management module 110 receives and standardizes time-series data from one or more sources, ensuring it is accessible for downstream processing. In parallel, the document processing module 115 ingests collections of unstructured documents such as earnings reports, regulatory filings, or healthcare records and applies advanced natural language processing (NLP) algorithms, including but not limited to optical character recognition (OCR), named entity recognition (NER), topic modeling, and sentiment analysis. This process transforms unstructured text into structured, machine-readable information, extracting and annotating key entities and concepts relevant to the forecasting task. The system is capable of sourcing time-series data either directly from unstructured documents or from separate structured data sources, providing robust support for scenarios where data may be incomplete or fragmented.

Time-series data may be sourced separately from the unstructured documents. For example, in financial market analysis scenario, a company's historical stock prices, trading volumes, and related quantitative indicators are collected as structured time-series data from a financial database or market data provider. This structured data typically follows a consistent schema, with fields such as timestamp, price, and volume recorded at regular intervals. Separately, a collection of unstructured documents such as earnings reports, regulatory filings, and news articles relevant to the company are gathered from various sources like corporate websites, regulatory agencies, or news feeds. These documents are rich in qualitative context but do not follow a fixed schema. In this scenario, the time-series data is ingested and processed independently to forecast future stock prices or trading activity. Meanwhile, the unstructured documents are processed to extract key entities, events, and sentiments. The two streams of data remain distinct throughout their initial processing stages and are only correlated at a later step, where the forecasted quantitative trends are aligned with the qualitative insights drawn from the documents.

The present invention also provides the flexibility for time-series data to be sourced directly from the unstructured documents by the document processing module 115, enabling a seamless integration of qualitative and quantitative information within a unified predictive narrative framework. Once extracted, these values are organized chronologically or according to another primary ordering variable, such as event sequence or spatial location, by the data ingestion and management module 110 to form a structured time series suitable for downstream forecasting and analysis. For example, financial metrics reported at different intervals in a series of earnings reports can be parsed and aligned by date to create a continuous time series reflecting revenue, expenses, or user growth over time. Similarly, clinical measurements or operational statistics mentioned in healthcare records or regulatory filings can be extracted and mapped to a temporal axis, enabling the system to reconstruct historical trends even when no explicit time-series database exists.

By automating the extraction and structuring of information from unstructured documents, the need for manual data entry and review, enhances the accuracy and consistency of data processing, and supports scalable, efficient integration of qualitative and quantitative data streams within the predictive narrative generation workflow. This automated extraction and transformation process addresses a major technical challenge: most traditional time-series models require structured, numerical inputs, but much of the valuable data in real-world organizations is locked within unstructured documents. By converting qualitative, text-based information into structured time-series data, the present invention enables organizations to unlock insights from previously untapped data sources, enrich their forecasting models, and generate predictive narratives that are both statistically grounded and contextually meaningful. The result is a more robust, flexible, and scalable approach to predictive analytics, supporting a wide range of applications where structured time-series data may be incomplete, fragmented, or entirely absent from traditional databases.

Once both data streams are prepared, a predictive modeling module 120 applies one or more forecasting algorithms to the time-series quantitative data, generating future value predictions. For example, the system incorporates a suite of established and state-of-the-art forecasting algorithms, each suited to different data patterns and forecasting requirements. Among these, a Long Short-Term Memory (LSTM) model is employed for its ability to capture long-term dependencies and complex temporal relationships within sequential data, making it especially effective for datasets with intricate or non-linear trends. A Gated Recurrent Unit (GRU) model, another advanced recurrent neural network, is included for its efficient handling of sequential data and its dual-gate architecture, which allows for precise control over information retention and update, thus supporting accurate forecasting in scenarios requiring fine-grained temporal modeling. For datasets where relationships are approximately linear or where data points are closely spaced, the system offers linear interpolation techniques, which provide a straightforward and computationally efficient means of estimating intermediate values and filling data gaps. Linear interpolation may also be used as a preliminary step before applying a more sophisticated forecasting technique. Additionally, the Neural Basis Expansion Analysis Time Series (N-BEATS) model is integrated for its block-based, fully connected architecture, which excels in high-volume and high-dimensional time-series forecasting tasks by iteratively refining predictions through multiple computational layers. These models are selected and recommended based on automated analysis of the source data's volume, complexity, and temporal characteristics, ensuring that the most appropriate algorithm is applied for each forecasting scenario. By providing this diverse set of forecasting algorithms, the system enables robust, flexible, and context-aware predictive modeling that underpins the generation of statistically grounded and contextually meaningful narrative outputs. The resulting forecasted values are then correlated with the entities and concepts identified from the unstructured documents through a dedicated correlation and alignment module 130. This module 130 is responsible for mapping quantitative predictions to qualitative insights, ensuring that the resulting associations are contextually meaningful and temporally aligned.

A narrative generation engine 140 synthesizes the correlated information into a coherent predictive narrative, iteratively refining the output to improve alignment between forecasted values and the contextual relevance of extracted entities. Throughout this workflow, user interaction is facilitated by interface 150, which allows users to upload data, select forecasting parameters, define scenario constraints, specify entities or document types of interest, and review or refine narrative drafts. The interface communicates directly with all modules, empowering users to maintain granular control over the process and supporting iterative refinement based on real-time feedback.

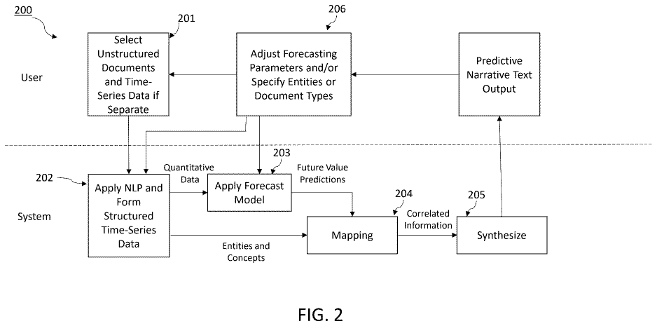

Referring now to FIG. 2, a method 200 for generating predictive narratives is depicted as a structured workflow according to an embodiment of the invention. The method 200 orchestrates the interaction of the modules within the computer-implemented system architecture 100. The process begins when the user uploads or selects at step 201 a collection of unstructured documents containing time-series data or associated with an uploaded or selected from a separate source of corresponding time-series data. At step 202, the time-series data is extracted from the unstructured documents, if needed, and validated to ensure that the quantitative data is standardized and accessible for downstream analysis. Advanced natural language processing algorithms, including named entity recognition, topic modeling, and sentiment analysis, are applied to extract and annotate key entities and concepts relevant to the forecasting task. This results in two data streams: a quantitative data stream associated with the time-series information and a qualitative data stream associated with the extracted entities and concepts.

Once both data streams are prepared, one or more forecasting algorithms are applied at step 203 to the validated time-series data, generating future value predictions. At step 204, the future value predictions are mapped to the entities and concepts extracted from the unstructured documents, ensuring that these associations are both contextually meaningful and temporally aligned. This correlated information is then synthesized at step 205 to produce a predictive narrative text that reflects plausible future scenarios grounded in both the time-series forecasts and the contextual richness of the extracted entities.

After the predictive narrative text is synthesized at step 205, user interaction is permitted to refine and tailor the narrative output, if needed. For example, users are able to review an initial predictive narrative and engage in a series of interactive steps to further customize the results. At step 206, the users may adjust forecasting parameters, such as modifying the forecasting horizon, changing scenario constraints, or specifying which key entities or document types should be emphasized in the narrative. The user selections may also upload additional time-series data or unstructured documents, or to focus the analysis on particular data subsets. Throughout this iterative process, the user provides real-time feedback, presenting updated drafts of the predictive narrative and supporting further refinements as needed. By facilitating seamless communication between the user and the system's core modules after step 205, the user maintains granular control over the narrative generation process, ensuring that the final outputs are both relevant and actionable for their specific analytical objectives.

By automating the extraction and structuring of information from unstructured documents and correlating it with quantitative forecasts, the invention addresses a major technical challenge: unlocking insights from previously untapped data sources and enabling organizations to generate predictive narratives that are both statistically robust and contextually meaningful. The system's modular design, comprehensive data processing capabilities, and user-centric workflow deliver a scalable, efficient, and actionable solution for predictive analytics and decision support, representing a significant advancement in the integration of AI-driven forecasting and narrative generation.

The present invention may be implemented as a distributed computing system optimized for processing temporal data sequences. In an embodiment of the invention, the system employs a multi-tier software architecture operating across networked computing nodes, each configured with sufficient computational resources (e.g., 8-core processors, 32 GB RAM, and 1 TB storage) to handle parallel data synthesis operations.

The embodiments described herein are meant to illustrate the inventive concepts contained herein. Other embodiments and modifications may be made to the compositions and methods without departing from the spirit and scope of the invention. Therefore, the scope of the present invention should not be limited to the embodiments described herein but should be defined by the appended claims and their equivalents.

We claim:

1. A computer-implemented method for generating predictive narratives, the method comprising the steps of:
receiving time-series data from one or more data sources;
applying one or more predictive models to the time-series data to forecast future values;
extracting key entities and concepts from a collection of unstructured documents using a natural language processing model;
correlating the forecast future values with the extracted key entities and concepts; and
generating a predictive narrative text that reflects a plausible future scenario based on the correlated forecast future values with the extracted key entities and concepts, wherein the predictive narrative text is not randomly generated.

2. The method of claim 1, wherein the time-series data comprises financial, user growth, or energy usage data.

3. The method of claim 2, wherein the unstructured documents include earnings reports, regulatory filings, or healthcare records.

4. The method of claim 1, further comprising the step of refining the predictive narrative text over multiple iterations to improve alignment between the forecast future values and plausible future scenario.

5. The method of claim 1, further comprising the step of tailoring the predictive narrative text through user-selectable parameter to a desired forecast horizon, key entity, or scenario constraint.

6. The method of claim 1, wherein the time-series data is organized according to an ordering variable selected from the group consisting of: spatial coordinates, sequential identifiers, dimensional measurements, energy-related variables, hierarchical structures, process-based progressions, developmental indicators, or environmental conditions.

7. The method of claim 1, wherein the predictive model is selected from the group consisting of: a long short-term memory (LSTM) model, a gated recurrent unit (GRU) model, a linear model, or a neural basis expansion analysis time series (N-BEATS) model.

8. The method of claim 1, wherein the natural language processing model further comprises named entity recognition, topic modeling, or sentiment analysis.

9. The method of claim 1, further comprising the step of exporting the predictive narrative text to an external analytics or reporting system.

10. The method of claim 1, wherein the predictive narrative text includes an explanation of how the forecasted values and extracted entities were correlated.

11. A computer-implemented system for generating predictive narratives, comprising:
a data ingestion module configured to receive time-series data from one or more data sources;
a document processing module configured to extract key entities and concepts from a collection of unstructured documents using a natural language processing model;
a predictive modeling module configured to apply one or more predictive models to the time-series data to forecast future values;
a correlation module configured to correlate the forecast future values with the extracted key entities and concepts; and
a narrative generation engine configured to generate a predictive narrative text that reflects a plausible future scenario based on the correlated forecast future values and extracted key entities and concepts, wherein the predictive narrative text is not randomly generated.

12. The system of claim 11, further comprising a user interface configured to receive user-selectable parameters for tailoring the predictive narrative text to a desired forecast horizon, key entity, or scenario constraint.

13. The system of claim 11, wherein the document processing module is further configured to extract time-series data directly from the unstructured documents.

14. The system of claim 11, wherein the correlation module is further configured to temporally align forecast future values with time-referenced entities or events extracted from the unstructured documents.

15. The system of claim 11, further comprising a feedback module configured to enable iterative refinement of the predictive narrative text based on user input or system-detected inconsistencies.

16. A non-transitory computer-readable storage medium storing instructions that, when executed by a processor, cause the processor to perform operations comprising:
receiving time-series data from one or more data sources;
extracting key entities and concepts from a collection of unstructured documents using a natural language processing model;
forecasting future values using one or more predictive models applied to the time-series data;
correlating the forecast future values with the extracted key entities and concepts; and
generating a predictive narrative text that reflects a plausible future scenario based on the correlation, wherein the predictive narrative text is not randomly generated.

17. The non-transitory computer-readable storage medium of claim 16, wherein the instructions further cause the processor to receive user input specifying a forecast horizon, key entity, or scenario constraint, and to tailor the predictive narrative text accordingly.

18. The non-transitory computer-readable storage medium of claim 16, wherein the instructions further cause the processor to extract time-series data from the unstructured documents.

19. The non-transitory computer-readable storage medium of claim 16, wherein the instructions further cause the processor to iteratively refine the predictive narrative text based on user feedback or system-detected misalignment between forecasted values and extracted entities.
